(19) United States
(12) Patent Application Publication
(10) Pub. No.: US 2024/0329893 A1
(43) Pub. Date: Oct. 3, 2024

(54) IMAGE PROCESSING APPARATUS, IMAGE PROCESSING METHOD, AND STORAGE MEDIUM

(71) Applicant: RISO KAGAKU CORPORATION, Tokyo (JP)

(72) Inventors: Takahisa YAMAZAKI, Tokyo (JP); Yuki URANO, Tokyo (JP); Masami IWAI, Tokyo (JP)

(21) Appl. No.: 18/615,746

(22) Filed: Mar. 25, 2024

(30) Foreign Application Priority Data
Mar. 29, 2023 (JP) 2023-053303

(51) Int. Cl. G06F 3/12

(52) U.S. Cl. CPC G06F 3/1208; G06F 3/1205; G06F 3/1255; G06F 3/1256

(57) ABSTRACT

An image processing apparatus includes a processor being configured to extract a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material, and to generate a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

### CROSS-REFERENCE TO RELATED APPLICATION

This application is based upon and claims the benefit of priority of the prior Japanese Patent Application No. 2023-053303 filed on Mar. 29, 2023, the entire contents of which are incorporated herein by reference.

### FIELD

Embodiments discussed herein are related to an image processing apparatus, an image processing method, and a storage medium.

### BACKGROUND

Conventionally, there has been proposed a printing assist system (see, for example, JP 2006-268441 A) that displays printing conditions under which printing can be performed with a smaller amount of ink when the remaining amount of ink is less than the amount of ink necessary for printing, and an information processing apparatus (see, for example, JP 2017-204806 A) that displays a warning in a case where a degree of occurrence of a problem in a printing result is a predetermined threshold or more.

### SUMMARY

According to one aspect, an image processing apparatus includes a processor being configured to extract a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material, and to generate a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

An object and advantages of the invention will be realized and attained by means of the elements and combinations particularly pointed out in the claims.

### BRIEF DESCRIPTION OF THE DRAWINGS

FIG. 1 is a diagram illustrating control configurations of a printing control apparatus and a printing apparatus according to an embodiment;

FIG. 2 is a diagram illustrating the printing apparatus according to the embodiment;

FIG. 3 is a diagram illustrating a print setting screen according to the embodiment;

FIG. 4 is a diagram illustrating a first print image part of which is highlighted (part 1) according to the embodiment;

FIG. 5 is a diagram illustrating the first print image part of which is highlighted (part 2) according to the embodiment;

FIG. 6 is a diagram illustrating a correlation table (part 1) according to the embodiment; and

FIG. 7 is a diagram illustrating the correlation table (part 2) according to the embodiment.

### DETAILED DESCRIPTION

Meanwhile, when printing is performed on a colored printing medium that is, for example, a printing medium such as a colored cloth, printing may be performed by applying pretreatment liquid containing a component that causes aggregation of ink, then applying white ink to form a white layer, and then applying color ink on it. In this case, the white layer has a role of clearing a color image formed on the white layer by hiding the color of the printing medium. At that time, depending on the characteristics such as the material of the cloth and the color of the cloth, how much pretreatment liquid and how much white ink that should be applied to make a clear image and a good durability (fastness to washing) are different. For example, since a polyester material has a property that pretreatment liquid or white ink easily penetrates the inside of the cloth, if the amount of the pretreatment liquid or the white ink is small, the amount of the white ink formed so as to cover the cloth decreases, and thus a white hiding ratio (white density) decreases, and the pattern obtained by the printing result is affected by the color of the printing medium. Since the cotton material has a property that the pretreatment liquid or the white ink is absorbed by fibers on the surface of the cloth and tends to remain in the vicinity of the surface of the cloth, a high white hiding ratio tends to be obtained as compared with the polyester material even if the amount of the pretreatment liquid or the white ink is small.

Meanwhile, if the amount of the pretreatment liquid with respect to the white ink is too small, the pretreatment liquid becomes so insufficient to aggregate the white ink that the white ink permeates into the cloth. Therefore, the white hiding ratio is lowered. On the other hand, if the amount of the pretreatment liquid with respect to the white ink is too large, the power to aggregate the white ink is too strong, which cracks the white ink and deteriorates the durability (e.g., fastness to washing).

Meanwhile, there are many factors that change the white hiding ratio and the fastness to washing, such as not only the material and color of the fiber, but also the dye used for coloring, the thickness of the fiber, the density, the way of knitting, and the thickness of the cloth. Therefore, even if a manufacturer indicates a guide of conditions (an amount of liquid) for a standard cloth, there is a problem that, in the case of using an unknown cloth, optimal conditions for each cloth cannot be known unless image quality is checked by actual printing and durability is checked by actual washing.

As described above, conventionally, the user has not been able to easily find the optimum or preferred printing conditions corresponding to the characteristic information such as image quality of a printed material after printing and the fastness to washing of the printed material after printing.

Hereinafter, an image processing apparatus, an image processing method, and a program according to an embodiment of the present invention will be described with reference to the drawings using a printing control apparatus, a printing control method, and a program as an example.

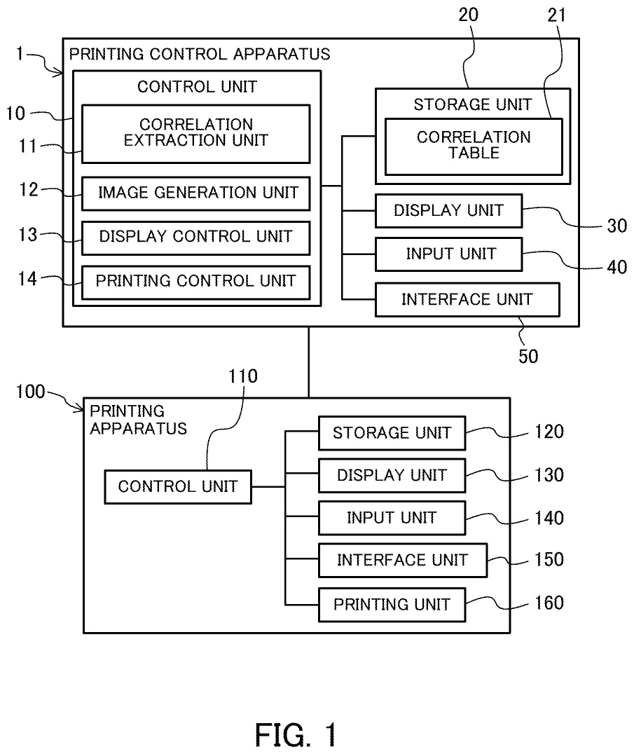

FIG. 1 is a diagram illustrating control configurations of a printing control apparatus 1 and a printing apparatus 100 according to the embodiment.

As illustrated in FIG. 1, the printing control apparatus 1 that is an example of the image processing apparatus includes a control unit 10, a storage unit 20, a display unit 30, an input unit 40, and an interface unit 50. A system including the printing control apparatus 1 and the printing apparatus 100 can be regarded as a printing system. The printing control apparatus 1 may be an apparatus dedicated to control the printing apparatus 100, or may be a user terminal (e.g., a tablet device, a smartphone, a notebook computer, or a desktop computer) or the like. Note that the image processing apparatus according to the present embodiment is not limited to the printing control apparatus 1, and may be an apparatus that does not control the printing apparatus 100 or may be the printing apparatus 100 itself. A system including such an image processing apparatus and the printing apparatus 100 can also be regarded as a printing system.

The control unit 10 includes, for example, one or more processors (such as a Central Processing Unit (CPU)) that function as an arithmetic processing device that controls the operation of each unit of the printing control apparatus 1. This processor functions as, for example, a correlation extraction unit 11, an image generation unit 12, a display control unit 13, and a printing control unit 14 by reading and executing a predetermined program from the storage unit 20 or from a storage medium (non-transitory computer-readable recording medium) attachable to and detachable from the printing control apparatus 1. As described above, the control unit 10 or the printing control apparatus 1 (the control unit 10 and the storage unit 20) functions as a computer that executes programs.

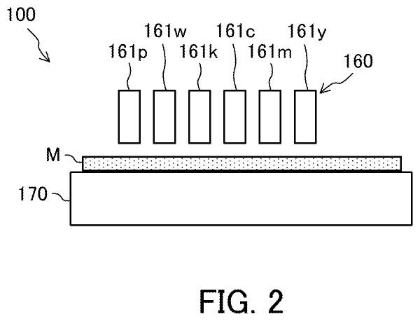

The correlation extraction unit 11 extracts from a correlation table 21 of the storage unit 20 a correlation between a type of printing medium M (see FIG. 2) used for printing that uses pretreatment liquid, white ink (an example of base ink), and color ink and printing conditions (the amount of the pretreatment liquid and the amount of the white ink), and image quality and characteristic information of a printed material. Here, the printed material can be referred to as the printing medium M in a printed state. Further, the color ink can be referred to as ink of one or more colors other than the base ink. Note that one of the amount of the pretreatment liquid and the amount of the white ink may be expressed as a ratio of the amount of the pretreatment liquid and the amount of the white ink.

Further, in the present invention, the characteristic information refers to characteristics other than image quality, and is, for example, information related to matters other than the finish of printing including durability such as fastness to washing (at least one of discoloration and contamination) and fastness to rubbing (at least one of discoloration and contamination), cost, and the total usage amount of the pretreatment liquid and the white ink, or information related to the finish of printing including texture. The cost is, for example, cost required for the pretreatment liquid and the white ink, or cost required when ink of another color is added in addition to the pretreatment liquid and the white ink. When the amount of the pretreatment liquid or the white ink increases, the cost may increase, or the time required for printing may increase. In the case of similar image quality and durability, it is preferable to use liquid with a smaller usage amount, but it is difficult for the user to find it. Thus, the characteristic information preferably includes the above-described cost, the total usage amount of the pretreatment liquid and the white ink, and the like in addition to the fastness to washing to be described below. Further, image quality may be determined from the viewpoint of white density, color developability, stains, cracks, and the like of the printed material.

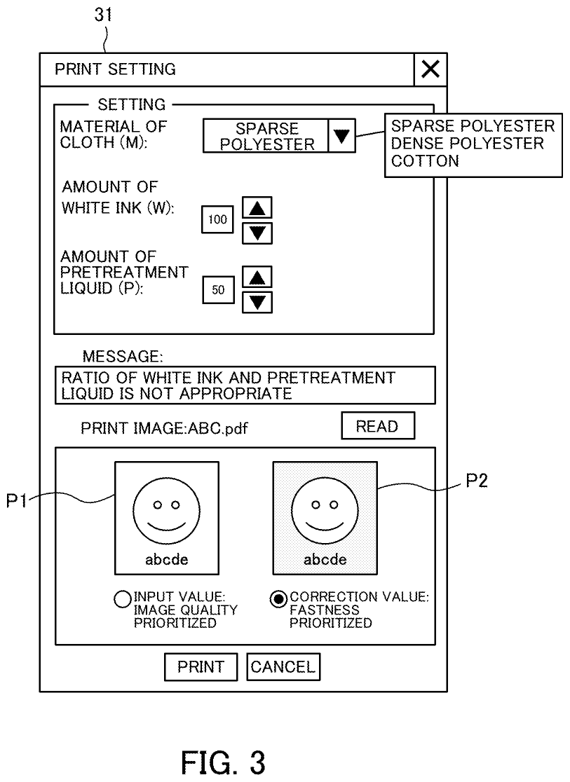

The image generation unit 12 generates a first print image P1 and a second print image P2 illustrated in FIG. 3 to be described later.

The display control unit 13 performs control to display a print setting screen 31 and the like illustrated in FIG. 3 on the display unit 30.

The printing control unit 14 controls a printing unit 160 of the printing apparatus 100. For example, the printing control unit 14 receives selection of one of the first print image P1 and the second print image P2, and controls the printing unit 160 under a condition matching the selected one image to control printing of the selected one image.

The storage unit 20 includes, for example, a memory such as a Read Only Memory (ROM) that is a read-only semiconductor memory in which a predetermined control program is recorded in advance, a Random Access Memory (RAM) that is a semiconductor memory that is used as a working storage area as necessary when the processor executes various control programs and is writable and readable at any time, a hard disk device, and the like.

The storage unit 20 stores the correlation table 21. This correlation table 21 indicates a correlation between the type of printing medium M (desirably the material of cloth and the color of the cloth of the printing medium M) and the printing conditions (the amount of the white ink and the amount of the pretreatment liquid), and image quality and characteristic information of a printed material. The storage unit 20 includes the correlation table 21, and thereby functions as an example of a correlation storage unit that stores the above correlation. Note that this correlation storage unit may be arranged in an apparatus different from the printing control apparatus 1.

The display unit 30 is a display that displays various types of information. For example, the display unit 30 displays the print setting screen 31 and the like illustrated in FIG. 3 on the basis of control of the display control unit 13.

The input unit 40 is an operation key, a touch panel, or the like that receives inputs of various types of information.

The interface unit 50 exchanges various types of information with various devices such as the printing apparatus 100 connected wirelessly or by wire via a network.

The printing apparatus 100 illustrated in FIG. 1 includes a control unit 110, a storage unit 120, a display unit 130, an input unit 140, an interface unit 150, the printing unit 160, and a stage 170 (see FIG. 2).

The control unit 110 includes, for example, one or more processors (such as a CPU) that functions as an arithmetic processing device that controls the operation of each unit of the printing apparatus 100. The storage unit 120 includes, for example, a memory such as a ROM that is a read-only semiconductor memory in which a predetermined control program is recorded in advance, a RAM that is a semiconductor memory that is used as a working storage area as necessary when the processor executes various control programs and is writable and readable at any time, a hard disk device, and the like. The display unit 130 is a display that displays various types of information. The input unit 140 is an operation key, a touch panel, or the like that receives inputs of various types of information. The interface unit 150 exchanges various types of information with various devices such as the printing control apparatus 1 connected wirelessly or by wire via a network.

As illustrated in FIG. 2, the printing unit 160 includes multiple heads 161p, 161w, 161k, 161c, 161m, and 161y.

The head 161p discharges the pretreatment liquid onto the printing medium M placed on the stage 170. Note that the printing medium M is, for example, a fabric such as a cloth or a woven fabric. The pretreatment liquid is not particularly limited as long as the pretreatment liquid is supplied to the printing medium M before printing of the color ink, and examples of the pretreatment liquid include liquid containing an aggregating agent such as a polyvalent metal salt, an organic acid, a cationic polymer, or a cationic surfactant, which reacts with ink to aggregate the ink.

The head 161w discharges the white ink, which is an example of the base ink. For example, the head 161w discharges the white ink after the head 161p discharges the pretreatment liquid. After the pretreatment liquid and the white ink are discharged, the heads 161k, 161c, 161m, and 161y discharge color inks of black, cyan, magenta, and yellow, respectively. Here, the reason why the white ink is printed as a base is to reduce the influence of the color of the printing medium M on the image formed with the color ink even if the printing medium M has a dark color such as black or dark blue. For example, when an image is formed using the color ink on a black cloth without a white layer, the image becomes blackish as compared with the case where the image is formed on a white cloth.

Note that, the ink may be applied to the cloth, to which the pretreatment liquid has been applied, by a so-called wet-on-wet method without going through a drying step, or the ink may be applied after the cloth to which the pretreatment liquid has been applied is dried. However, it is preferable that the white ink is applied to the printing medium by a wet-on-wet method after the pretreatment liquid is attached to form a white image, and the non-white ink is further applied by a wet-on-wet method to form a non-white image. The white ink and the color ink can be fixed to the printing medium M by drying the printing medium M at a high temperature after the printing unit 160 discharges the pretreatment liquid, the white ink, and the color ink.

FIG. 3 is a diagram illustrating the print setting screen 31.

The print setting screen 31 illustrated in FIG. 3 is an example of a screen displayed on the display unit 30 under control of the display control unit 13 illustrated in FIG. 1, and is a screen for making a print setting. The material of the cloth is selected as the information on the type of printing medium M in a setting field of the print setting screen 31. For example, the material of the cloth is sparse polyester, dense polyester, cotton, or the like. Note that the information on the printing medium M preferably includes the color of the cloth such as black, blue, red, or yellow, and the present embodiment will describe an example where the color of the cloth is black.

Recommended values (100 and 50) associated with the material of the cloth are displayed in “amount of white ink (W)” and “amount of pretreatment liquid (P)” in setting fields of the print setting screen 31. Further, the first print image P1 (e.g., a face image and letters of “abcde”) that will be described later and is a printing target image associated with the amounts of the white ink and the pretreatment liquid in the setting fields is displayed in the print image field. For example, the user can check the first print image P1, and manually increase numerical values of the amounts of the white ink and the pretreatment liquid by an upward arrow or decrease the numerical values by a downward arrow. Thus, when at least one of the amount of the white ink and the amount of the pretreatment liquid is changed, the first print image P1 may also change to the corresponding first print image P1 on the basis of the changed amount.

A warning message is displayed in a field of “message” on the print setting screen 31 when the correlation extraction unit 11 refers to the correlation table 21, and the ranges of the amount of the white ink and the amount of the pretreatment liquid input in the above setting field are out of recommended setting ranges. For example, in the example of FIG. 3, “ratio of white ink and pretreatment liquid is not appropriate” is displayed. Note that, depending on the cloth used by the user, values outside the recommended setting range may bring a better balance in image quality and fastness, and thus the message merely gives notice.

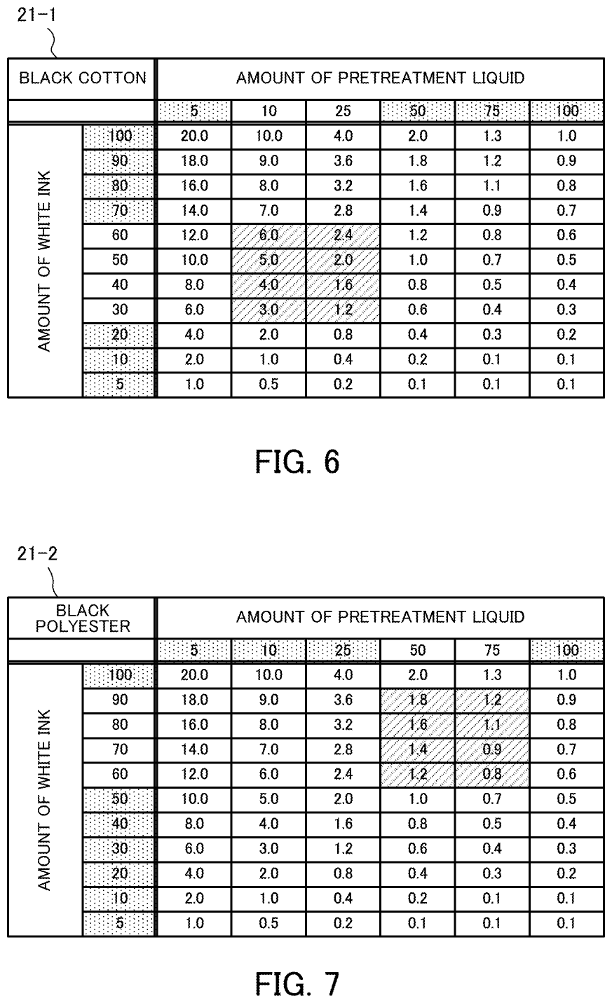

FIG. 6 is a diagram illustrating a correlation table 21-1.

The correlation table 21-1 illustrated in FIG. 6 is an example where the cloth of the printing medium M is black cotton, and shows the amount of the white ink (100, 90, 80, 70, 60, 50, 40, 30, 20, 10, and 5) on the vertical axis, the amount of the pretreatment liquid (5, 10, 25, 50, 75, and 100) on the horizontal axis, and the ratio (such as 20.0 that is the amount of white ink/the amount of pretreatment liquid or the like) associated with these amounts.

The amounts of the white ink (100, 90, 80, 70, 20, 10, and 5) shown in the dot pattern background indicate that the amounts of the white ink are larger or smaller than the recommended setting range. Further, the amounts of the pretreatment liquid (5, 50, 75, and 100) shown in the dot pattern background indicate that the amounts of the pretreatment liquid are smaller or larger than the recommended setting range. Here, when the amount of the white ink is too large, the white ink becomes excessive, and white spots and stains tend to be produced. Furthermore, when the amount of the white ink is too small, the white density (white hiding property) and the fastness to washing tend to be low. Furthermore, when the amount of the pretreatment liquid is too small, the white density tends to be low. Furthermore, when the amount of the pretreatment liquid is too large, the fastness to washing tends to be low. Taking these phenomena into account, the recommended setting ranges of the white ink and the pretreatment liquid may be empirically obtained by actually performing washing and a durability test.

In the example in FIG. 6, when the amount of the white ink is 60, 50, 40, or 30 and the amount of the pretreatment liquid is 10 or 25 (a corresponding ratio portion is indicated by diagonal lines), it can be said that the white ink or the pretreatment liquid is within the recommended setting range. Note that, according to one of the amounts (e.g., white ink), the recommended setting range of the other one (e.g., pretreatment liquid) among the recommended setting ranges of the amounts of the white ink and the pretreatment liquid may differ.

FIG. 7 is a diagram illustrating a correlation table 21-2.

The correlation table 21-2 illustrated in FIG. 7 is an example where the cloth of the printing medium M is black sparse polyester, and can be similar to the correlation table 21-1 illustrated in FIG. 6 except for the recommended setting ranges.

The amounts of the white ink (100, 50, 40, 30, 20, 10, and 5) shown in the dot pattern background indicate that the amounts of the white ink are larger or smaller than the recommended setting range. Further, the amounts of the pretreatment liquid (5, 10, 25, and 100) shown in the dot pattern background indicate that the amounts of the pretreatment liquid are smaller or larger than the recommended setting range.

In the example of FIG. 7, when the amount of the white ink is 90, 80, 70, or 60 and the amount of the pretreatment liquid is 50 or 75 (the corresponding ratio portion is illustrated by diagonal lines), it can be said that the white ink and the pretreatment liquid are within the recommended setting ranges.

Returning to FIG. 3, a printing target image (copy) that is an original of the first print image P1 and the second print image P2 can be read in the field of “print image” on the print setting screen 31. The file format is, for example, image data (that is not limited to PDF, and may be JPEG, PNG or the like) such as “ABC.pdf”, and a print image P may be adjusted by functions such as scaling and trimming although not illustrated.

The first print image P1 and the second print image P2 generated by the image generation unit 12 are displayed in the print image field. The first print image P1 is an image based on the type of printing medium M and input values of the amount of the pretreatment liquid and the amount of the base ink that have been input in the setting field as described above. The second print image P2 is an image based on correction values that improve at least one of image quality and characteristic information as compared with the input values that are the amount of the pretreatment liquid and the amount of the base ink, and that are the amount of the pretreatment liquid and the amount of the base ink on the basis of the correlation between the type of printing medium M, the amount of the pretreatment liquid, and the amount of the base ink, and the image quality and the characteristic information of the printed material extracted from the correlation table 21 by the correlation extraction unit 11 as described above. This correction value is, for example, a value closest to the input value among the combinations of the amount of the pretreatment liquid and the amount of the white ink whose ratio portions are indicated by the diagonal lines in FIGS. 6 and 7. Here, improvement of image quality corresponds to an increase in white density, an increase in color developability, a decrease of stains, a decrease of cracks, and the like of the printed material, and improvement of characteristic information corresponds to an increase in durability such as fastness to washing and fastness to rubbing, a decrease in cost, a decrease in the total usage amount of the pretreatment liquid and the white ink, improvement in texture, and the like. Note that, if an image quality priority mode, a fastness (characteristic information) priority mode, and the like can be set on the print setting screen 31, a correction value that prioritizes one of the image quality or the fastness to which the priority mode is set may be adopted. Further, when the first print image P1 is within the recommended setting range in terms of the image quality and the characteristic information, generation of the second print image P2 may be omitted. In other words, the image generation unit 12 may generate the second print image P2 when the input values of the amount of the pretreatment liquid and the amount of the base ink that have been input are out of the recommended setting ranges.

The print setting screen 31 enables selection of only one of a check field of “input value: image quality prioritized” under the first print image P1, and a check field of “correction value: fastness prioritized” under the second print image P2. In the examples of the above-described correlation tables 21-1 and 21-2 illustrated in FIGS. 6 and 7, both of the image quality and the fastness to washing (characteristic information) indicate the recommended amount of the white ink and the recommended amount of the pretreatment liquid. Hence, when the image generation unit 12 determines the correction values on the basis of this recommended range, and generates the second print image P2 matching these correction values, both of the image quality and the fastness of the second print image P2 are often improved more than those of the first print image P1. However, FIG. 3 illustrates an example where the second print image P2 has the image quality that becomes lower than that of the first print image P1, and the fastness (characteristic information) that is improved more than that of the first print image P1. Hence, as described above, “image quality prioritized” is displayed in a field of the input value under the first print image P1, and “fastness prioritized” is displayed in a field of the correction value under the second print image P2. Note that a numerical value of the fastness to washing (e.g., grade) or the like may be displayed instead of the words of “fastness prioritized”. Further, the second print image P2 may have image quality that is improved more than that of the first print image P1 and characteristic information that becomes lower than that of the first print image P1, or may have image quality and characteristic information both of which are improved more than those of the first print image P1. Further, a plurality of the second print images P2 whose at least one of the image quality and the characteristic information of the printed material are different from each other may be generated. In this case, the user has more options for a printing target image.

When a “print” button on the print setting screen 31 is pressed, the printing control unit 14 controls printing of one selected image of the first print image P1 and the second print image P2 by controlling the printing unit 160 under the printing conditions matching the one selected image. On the other hand, when a “cancel” button is pressed, printing is not performed. Note that the first print image P1 and the second print image P2 may be used for test printing. Further, a printing target may not be selected from the first print image P1 and the second print image P2. In this case, the correction values of the amounts of the pretreatment liquid and the white ink displayed on the print setting screen 31 together with the second print image P2 are useful as a reference when the user inputs the amounts of the pretreatment liquid and the white ink.

By the way, depending on the material and the color of the printing medium M, the amount of the pretreatment liquid, and the amount of the color ink, for example, a printed material that has actually been printed has white spots and stains produced when the amount of the white ink is too large, and has a lowered white density caused when the amount of the white ink is too small. Meanwhile, if the amount of the pretreatment liquid with respect to the white ink is too small, the pretreatment liquid becomes so insufficient to aggregate the white ink that the white ink penetrates into the cloth. Therefore, the white hiding ratio is lowered. On the other hand, if the amount of the pretreatment liquid with respect to the white ink is too large, the power to aggregate the white ink is too strong, which cracks the white ink and deteriorates the durability (e.g., fastness to washing). Further, for example, when the printing medium M is a black cloth, a crack and the like of the white ink may be more noticeable at a printing portion of the color ink with high saturation. As described above, image quality of an actual printed material may partially deteriorate as compared with the first print image P1.

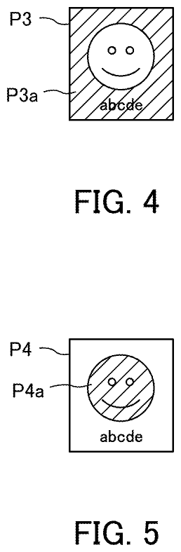

Hence, in a case where image quality deterioration conditions associated with the type of printing medium M and the amounts of the white ink, the pretreatment liquid, and the color ink are determined in advance, the image generation unit 12 can specify the portion at which image quality deteriorates as a white portion of a background portion, a portion printed with other color inks, part of the portion printed with the color ink, or the like by referring to these conditions. Hence, the image generation unit 12 may specify a portion of the first print image P1 at which the image quality deteriorates in the printed material by highlighting with oblique lines or the like an image quality deterioration portion P3a that is a background portion as in the first print image P3 illustrated in FIG. 4, and by highlighting with oblique lines or the like an image quality deterioration portion P4a that is a portion (face image portion) printed with color ink as in the first print image P4 illustrated in FIG. 5. These first print images P3 and P4 may be displayed on the print setting screen 31 instead of the first print image P1 illustrated in FIG. 3, or may be displayed at another position in addition to the first print image P1 illustrated in FIG. 3. Note that highlighting may adopt any method such as addition of diagonal lines or the like to the image quality deterioration portions P3a and P4a, and coloring of the image quality deterioration portions P3a and P4a.

In a case where the image quality deterioration portions P3a and P4a are highlighted, the display unit 30 may supplementarily display, on the print setting screen 31, sentences of description that a diagonal line portion, a colored portion, or the like of the image quality deterioration portions P3a and P4a indicated by a highlighting method is a portion at which the image quality may deteriorate in the printed material, description on how the image quality deteriorates, or the like in order to facilitate user's understanding. Note that the target to highlight the image quality deterioration portions P3a and P4a is not limited to the first print images P1, P3, and P4, and may be only the second print image P2 or may be both of the first print image P1 and the second print image P2.

In the above-described present embodiment, the printing control apparatus 1 that is an example of the image processing apparatus includes the correlation extraction unit 11 and the image generation unit 12. The correlation extraction unit 11 extracts a correlation from the correlation storage unit (e.g., the storage unit 20 that stores the correlation table 21) that stores the correlation between the type of printing medium M used for printing that uses the pretreatment liquid, the white ink (an example of the base ink), and the color ink, the amount of the pretreatment liquid, and the amount of the base ink, and the image quality (e.g., the white density, cracks, and the like) and the characteristic information (e.g., fastness to washing) of the printed material. The image generation unit 12 generates the first print image P1 and the second print image P2. The first print image P1 is an image based on the type of printing medium M and input values of the amount of the pretreatment liquid and the amount of the base ink that have been input. The second print image P2 is an image based on the correction values that improve at least one of the image quality and the characteristic information more than the input value, and are the amount of the pretreatment liquid and the amount of the base ink obtained from the above correlation.

From the viewpoint of the printing control method (an example of the image processing method), the printing control method performed by the computer (e.g., the control unit 10, the printing control apparatus 1, and the like) includes: extracting the correlation from the correlation storage unit (e.g., the storage unit 20 that stores the correlation table 21) that stores the correlation between the type of printing medium M used for printing that uses the pretreatment liquid, the white ink (an example of the base ink), and the color ink, the amount of the pretreatment liquid, and the amount of the base ink, and the image quality (e.g., the white density, cracks, and the like) and the characteristic information (e.g., fastness to washing) of the printed material; and generating the first print image P1 based on the type of printing medium M and input values of the amount of the pretreatment liquid and the amount of the base ink that have been input, and the second print image P2 based on correction values that improve at least one of the image quality and the characteristic information more than the input values and that are the amount of the pretreatment liquid and the amount of the base ink obtained from the above correlation.

From the viewpoint of the program, the program causes the computer (e.g., the control unit 10, the printing control apparatus 1, and the like) to implement: a function of extracting the correlation from the correlation storage unit (e.g., the storage unit 20 that stores the correlation table 21) that stores the correlation between the type of printing medium M used for printing that uses the pretreatment liquid, the white ink (an example of the base ink), and the color ink, the amount of the pretreatment liquid, and the amount of the base ink, and the image quality (e.g., the white density, cracks, and the like) and the characteristic information (e.g., fastness to washing) of the printed material; and a function of generating the first print image P1 based on the type of printing medium M and input values of the amount of the pretreatment liquid and the amount of the base ink that have been input, and the second print image P2 based on correction values that improve at least one of the image quality and the characteristic information more than the input values and that are the amount of the pretreatment liquid and the amount of the base ink obtained from the above correlation.

These printing control apparatus 1, printing control method, and program can present to the user the first print image P1 matching the input values of the amounts of the pretreatment liquid and the white ink, and the second print image P2 matching the correction values of the amounts of the pretreatment liquid and the white ink that improve at least one of the image quality and the characteristic information more than the input valuer. Consequently, the user can check the image quality and the characteristic information of the printed material that cannot be checked unless printing is actually performed. Consequently, according to the present embodiment, it is possible to easily obtain a printed material desired by the user.

Further, in the present embodiment, the printing control unit 14 receives selection of one of the first print image P1 and the second print image P2, and controls printing of the selected one image.

Consequently, the user can obtain a desired printed material by a simple operation of selecting one of the first print image P1 and the second print image P2.

Further, in the present embodiment, the image generation unit 12 highlights portions (e.g., the image quality deterioration portions P3a and P4a of the first print images P3 and P4) at which image quality deteriorates in the printed material of the first print image P1 (an example of at least one of the first print image P1 and the second print image P2).

Consequently, the user can easily grasp which part of the first print image P1 or the second print image P2 in the printed material image quality deteriorates. Consequently, by checking the image quality deterioration portions P3a and P4a, for example, changing the input values of the amounts of the pretreatment liquid and the white ink, and improving the image quality deterioration portions P3a and P4a, the user can obtain the printed material that more meets a user's desire.

Further, in the present embodiment, the image generation unit 12 generates the second print image P2 when the input values that are the amounts of the pretreatment liquid and the white ink are out of the recommended setting ranges.

Consequently, when the amounts of the pretreatment liquid and the white ink are within the recommended setting ranges, generation of the second print image P2 can be omitted. Consequently, by presenting the second print image P2 to the user only when necessary, it is possible to more easily obtain a printed material desired by the user.

The present invention is not limited to the above-described embodiment as it is, and the constituent elements can be modified and embodied without departing from the gist thereof at the implementation stage. Furthermore, various inventions can be formed by appropriately combining a plurality of constituent elements disclosed in the embodiment. For example, all the constituent elements shown in the embodiment may be appropriately combined. It is a matter of course that various modifications and applications can be made without departing from the gist of the invention. Hereinafter, some inventions described in the specification of the present application will be additionally described.

According to an aspect, an image processing apparatus includes a processor being configured
to extract a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material, and
to generate a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

According to another aspect, the processor receives selection of one of the first print image and the second print image, and controls printing of the selected one of the first print image and the second print image.

According to another aspect, the processor highlights a portion at which the image quality deteriorates in the printed material of at least one of the first print image and the second print image.

According to another aspect, the processor generates the second print image when the input value is out of a recommended setting range.

According to another aspect, an image processing method performed by a computer includes:
extracting a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material; and
generating a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

According to another aspect, a non-transitory storage medium storing a program causes a computer to execute a process includes:
extracting a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material; and
generating a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

What is claimed is:

1. An image processing apparatus comprising a processor being configured
to extract a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material, and
to generate a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

2. The image processing apparatus according to claim 1, wherein the processor receives selection of one of the first print image and the second print image, and controls printing of the selected one of the first print image and the second print image.

3. The image processing apparatus according to claim 1, wherein the processor highlights a portion at which the image quality deteriorates in the printed material of at least one of the first print image and the second print image.

4. The image processing apparatus according to claim 1, wherein the processor generates the second print image when the input values are out of a recommended setting range.

5. An image processing method performed by a computer comprising:
extracting a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material; and
generating a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.

6. A non-transitory storage medium storing a program causes a computer to execute a process comprising:
extracting a correlation from a correlation table that indicates the correlation between a type of printing medium used for printing that uses pretreatment liquid, base ink, and color ink, an amount of the pretreatment liquid, and an amount of the base ink, and image quality and characteristic information of a printed material; and
generating a first print image based on the type of printing medium and input values of the amount of the pretreatment liquid and the amount of the base ink that have been input, and a second print image based on correction values that improve at least one of the image quality and the characteristic information more than the input values and that are the amount of the pretreatment liquid and the amount of the base ink obtained from the correlation.
